(19) United States
(12) Patent Application Publication
(10) Pub. No.: US 2005/0033852 A1
(43) Pub. Date: Feb. 10, 2005

(54) System, apparatus, and method for providing presence boosted message service reports

(76) Inventor: Jouko Tenhunen, Helsinki (FI)

Correspondence Address: Crawford Maunu PLLC, Suite 390, 1270 Northland Drive, St. Paul, MN, 55120, US

(21) Appl. No.: 10/619,377

(22) Filed: Jul. 14, 2003

(51) Int. Cl. G06F 15/16

(52) U.S. Cl. 709/229; 709/230

(57) ABSTRACT

A system, apparatus, and method is provided for automatically providing presence information using existing messaging services. Backward messaging such as read reports and delivery reports automatically include presence information from presence server (334) according to user preferences contained within profile database (332). The presence information may be disseminated through any messaging service, such as the Multimedia Messaging Service (MMS) and is also supported by Session Initiated Protocol (SIP) signalling.

### FIELD OF THE INVENTION

This invention relates in general to messaging services, and more particularly, to presence information boosted messaging services.

### BACKGROUND OF THE INVENTION

The mobile industry has experienced a period of exceptional growth over the last decade. The next wave of growth is expected to come from mobile services, that are enabled by service enablers based on open global standards. The Multimedia Messaging Service (MMS), Java, and the Extensible HyperText Markup Language (XHTML) will enable compelling new services for consumers and new sources of growth for the mobile industry.

Service enablers are the basic technology building blocks for creating mobile services. The implementation of service enablers could take place at many places in the end-to-end (e2e) chain, in the form of, e.g., mobile device software, server software, and development tools. Many new service enablers are needed for the production of new, compelling mobile services and for vitalizing the next growth wave for the mobile industry.

The key criteria for service enablers are that they: enable new and better services for consumers; provide developers with facilities that speed up the development of new services; make new business possible for industry stakeholders; and are based on open global standards that ensure interoperability. To insure successful take-up of mobile services, it is important to minimize the fragmentation of service enablers and to insure seamless interoperability between different vendors. The Open Mobile Alliance (OMA), therefore, operates with the cooperation of mobile communication leaders to promote open global standards and the interoperability of service enablers.

Some examples of service enablers, based on the open global standards, that are needed to create a service platform for the future include: multimedia messaging, browsing, Mobile Digital Rights Management (MDRM), location, presence, and Instant Messaging to name only a few. Experience with the extremely successful Short Messaging Service (SMS) has highlighted three important areas for consideration: technologies based on the open global standard; the business system; and the portfolio of services and content.

Maintaining a portfolio of compelling services and content is a critical requirement in driving a successful mobile services market. The consumer should be the focus, since the consumer is the key to new service acceptance. A balanced business system is also required for mobile service success, since healthy, profit making logic for all players within the mobile service ecosystem maintains a high level of motivation among the members of the business system to contribute to the mobile service success. By following and being consistent with open global standards, content providers, application developers, vendors/manufacturers, carriers and Information Technology (IT) vendors will be able to provide consumers with a wide selection of different, but interoperable devices and services.

As the service enablers grow and evolve with their corresponding services, cross-enabling and inter-working within the established services will tend to occur in order to enhance the end user experience. For example, in order to meet consumer's expectations of the usability of messaging enablers, such as MMS, a new mechanism is needed, whereby presence may be combined with MMS to provide the sender of an MMS message with presence information associated with the recipient of the MMS message. Today, there is no standardized mechanism through which the sender of an MMS message may obtain, for example, the availability of the recipient of the MMS message without first having to subscribe to the recipient's presence information.

Accordingly, there is a need in the communications industry to automatically exchange presence information through various messaging methods and protocols to provide the mobile service user with an enhanced experience. Such an enhanced experience provides the user with added confidence that his message is deliverable and readable by the intended recipient, thus promoting and growing a new method of communication.

### SUMMARY OF THE INVENTION

To overcome limitations in the prior art, and to overcome other limitations that will become apparent upon reading and understanding the present specification, the present invention discloses a system, apparatus, and method for automatically providing presence information in backward messaging such as acknowledgments and receipt confirmations.

In accordance with one embodiment of the invention, a method for propagating presence information is provided. The method comprises transmitting a message from a first network entity to a second network entity, receiving the message using a messaging service of the second network entity, gathering presence information associated with the second network entity by the messaging service, and providing the presence information in backward messaging to the first network entity.

In accordance with another embodiment of the invention, a messaging system is provided. The messaging system comprises a first terminal coupled to transmit a message, a network element coupled to relay the message and to provide acknowledgment of message receipt to the first terminal, and a second terminal coupled to receive the message, wherein presence information is attached to the acknowledgment by the network element to automatically update the first terminal with second terminal presence information without the need for the first terminal to explicitly subscribe to second terminal's presence information.

In accordance with another embodiment of the invention, a mobile terminal wirelessly coupled to a network which includes a network element capable of accessing presence information is provided. The mobile terminal comprises a memory capable of storing at least one of a messaging module and a presence processor, a processor coupled to the memory and configured by the messaging module to enable a backward message exchange with the network element, and a transceiver configured to facilitate the message exchange with the network element, wherein the processor is configured by the presence processor to display the presence information attached to the backward message.

In accordance with another embodiment of the invention, a computer-readable medium having instructions stored thereon which are executable by a first mobile terminal for exchanging messages is provided. The instructions perform steps comprising transmitting a message to a second mobile terminal, receiving an acknowledgment message from a messaging service of the second mobile terminal, and displaying presence information contained within the acknowledgment message, wherein the presence information is populated by the messaging service.

In accordance with another embodiment of the invention, a server within a network used to facilitate an exchange of messages is provided. The server comprises means for receiving a message from a first terminal, means for extracting presence information associated with a recipient of the message, and means for providing the presence information to the first terminal in a backward message.

In accordance with another embodiment of the invention, a computer-readable medium having instructions stored thereon which are executable by a network server for facilitating messaging is provided. The instructions perform steps comprising receiving messages from a first network terminal, obtaining presence information associated with a recipient of the messages, formatting the presence information into a backward message in accordance with profile information associated with the recipient of the messages, and sending the backward message to the first network terminal.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates an exemplary Multimedia Messaging Service (MMS) network in accordance with the present invention;

FIG. 2 illustrates an exemplary presence information format in accordance with the present invention;

FIG. 3 illustrates an exemplary network diagram in accordance with the present invention;

FIG. 4 illustrates an exemplary read report in accordance with the present invention;

FIG. 5 illustrates an exemplary Session Initiated Protocol (SIP) network in accordance with the present invention;

FIG. 6A illustrates an exemplary SIP messaging sequence in accordance with the present invention;

FIG. 6B illustrates an exemplary SIP enabled multimedia message flow according to the present invention;

FIG. 6C illustrates a SIP request message structure according to the prior art;

FIG. 6D illustrates an exemplary SIP request message structure according to the present invention;

FIG. 7 illustrates one embodiment of presence information display according to the present invention;

FIG. 8 illustrates another embodiment of presence information display according to the present invention;

FIG. 9 illustrates a representative mobile computing arrangement in accordance with the present invention; and

FIG. 10 is a representative computing system capable of carrying out messaging functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that combines messaging and presence service enablers to enhance the end-user's experience. Through the combination of presence information with MMS delivery reports, read reports, and other acknowledgements, the sender of MMS messages, for example, may be provided with the recipient's presence information. In such a case, the sender may gain added insight as to whether the recipient of the message is able to immediately respond to the MMS message, or if the recipient is going to delay the response due to his current activity. Presence information may also be propagated by embedding the presence information within, for example, Session Initiation Protocol (SIP) headers during media session setup and Instant Messaging (IM) messaging using SIP.

MMS is standardized globally and delivers a location-independent messaging experience combined with ease of use. MMS is a simple and logical extension of the SMS capability, adding new functions and new content types such as photographs, video clips, maps, graphs, layouts, plans, and animations that may be exchanged with other mobile users. The MMS standard also defines messaging between Internet applications and mobile devices as well as support for flexible addressing of multimedia messages to both familiar phone numbers and e-mail. It is expected that MMS service will evolve to serve also store & forward needs in IP Multimedia Subsystem (IMS) and IP Multimedia Domain (MMD) networks.

Combining MMS with presence according to the present invention, the sender of an MMS message will know, for example, whether the other party is immediately available to respond to the message, or whether he or she is temporarily detained. The communication system, apparatus, and method according to the present invention, therefore, enables the paradigm of—look before you communicate. Prior to initiating communication, the sender of an MMS message is also able to determine if the other parties wish to communicate, or by what means they would prefer to be contacted. Thus, use of the present invention enables the sender of a multimedia message to gain access to the recipient's presence information without explicitly subscribing to it.

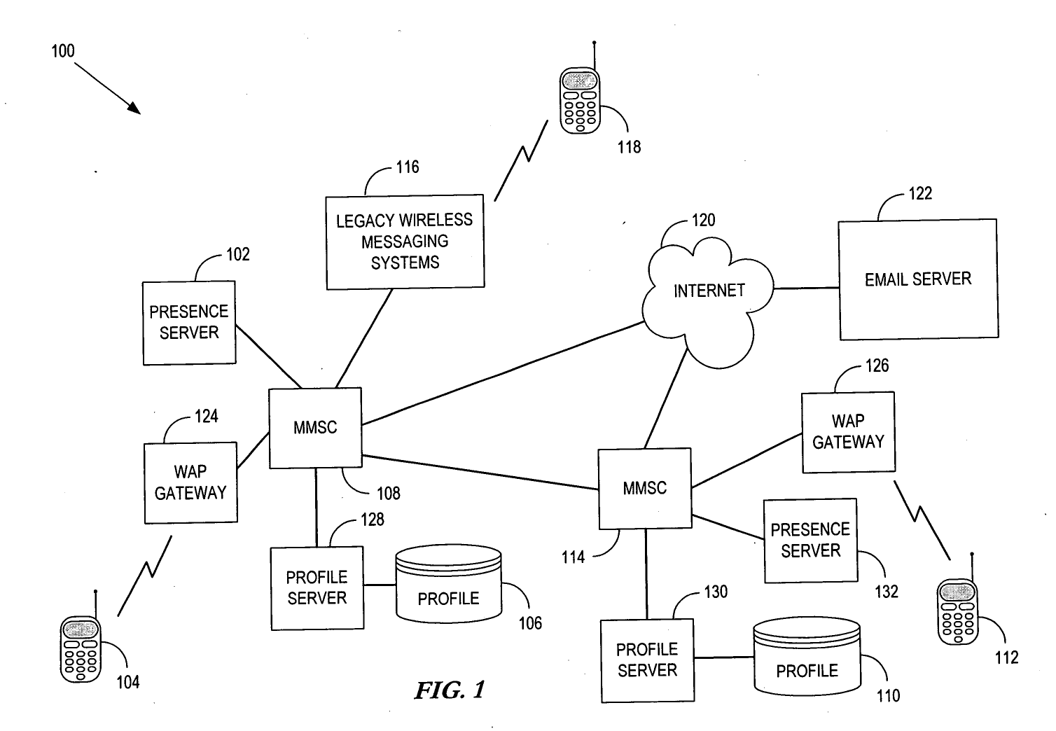

FIG. 1 illustrates MMS network 100 in accordance with the present invention. One feature of MMS network 100 is the ability of MMSC 108 to support the messaging capabilities of legacy wireless messaging systems 116 that support legacy wireless devices 118. Legacy wireless messaging systems 116 support messaging systems that currently enjoy a large number of subscribers, such as paging and SMS. Mobile terminals 104 and 112 represent more recent wireless terminals that support the Wireless Application Protocol (WAP), where any bearer supporting WAP may be used, such as the Global System for Mobile Communications (GSM) or Wideband Code Division Multiple Access (WCDMA). MMS uses the Wireless Session Protocol (WSP) at the protocol level for message transport from mobile terminals 104 and 112 to WAP gateways 124 and 126, respectively.

MMSC 108 and 114 are store-and-forward network elements that deliver MMS messages from the sender, e.g., mobile terminal 104, to the recipient, e.g., mobile terminal 112. After the receiving device has been found, MMSC 114 immediately notifies the receiving device to invoke the retrieval of the message. After the retrieval, the message is deleted from the MMSC if it was successfully delivered, or alternatively, stored for future use. MMSC 108 and 114 host a number of interfaces for connecting to other networks, e.g., legacy wireless messaging systems 116 and Internet 120, as well as Web Service Interface, e.g., MM7, to enable the delivery of value-added services. MMSC 108 and 114 also provide interfaces to allow message transfer with e-mail server 122, such that Simple Mail Transfer Protocol (SMTP), Post Office Protocol (POP) and/or Internet Message Access Protocol (IMAP) transport mechanisms may be supported.

MMSC 108 and 114 utilize WAP gateways 124 and 126, respectively, to access the mobile networks supporting mobile terminals 104 and 112. The transmission bearers capable of supporting the bandwidths required by the multimedia content of MMS messages include single slot GSM data, High Speed Circuit Switched Data (HSCSD), and General Packet Radio Service (GPRS), but other bearers and protocols may be used. Profile databases 106 and 110 represent data stores accessible by their respective profile servers, 128 and 130, to personalize MMS for the users of mobile terminals 104 and 112. Profiles 106 and 110 store vital information such as the device capabilities of mobile terminals 104 and 112, user's preferences, and information about subscription details. In addition, the users have more control and flexibility in deciding how they want to send, receive and filter MMS messages based on their respective profile information stored in profile databases 106 and 110.

MMS network 100, in accordance with the present invention, expands the mobile context from one of providing on-line information via IM, to one of providing a powerful tool of self-expression and continuous mobile awareness through the use of presence services. Mobile terminals 104 and 112 are already the primary means of storage for contact information, since they are in virtually constant contact with their users. Presence services according to the present invention support all mobile communications, including real-time and delayed text messaging and relayed and delayed speech. Presence information is not restricted to named persons, but can also refer to un-named persons, groups, intelligent devices, documents, etc.

When presence information stored in, e.g., presence servers 102 and 132, is combined with contact information stored in, e.g., the phonebook of mobile terminals 104 and 112, a dynamic entity is created that naturally extends and enriches the static representation of contacts. Presence services enable more sharing of private information within small trusted groups as well as sharing availability information with a wider audience in order to enable more appropriate and effective communication.

Presence entities like presentity, watcher, and location have been promulgated by the Internet Engineering Task Force (IETF) to describe a wide range of distributed application scenarios requiring presence awareness. Presence awareness provides location, identity, and activity information concerning the neighbors of someone or something which is present somewhere. A location is a virtual or real place where someone or something is located or is present and is usually associated with either documents or hosts. In the case of documents, Uniform Resource Locators (URL) provide the addresses to HyperText Markup Language (HTML) or text documents and they may be used as locations to open the document. Once opened, the document is considered to be present. In the case of hosts, being logged into the host could qualify as being present, where the associated location may be specified by an Internet Protocol (IP) address and augmented using a port number. A higher level abstraction having location flavor may be represented by a chat room, or a mobile terminal enabled video conference having several members.

A presentity is a uniquely identified entity that is present at a location having, for example, a “user@domain” identifier. A presentity need not be a user, however, and may also be represented as a running program or a user agent. A presentity has presence information associated with it, such as its location and current state. The current state of a presentity may be represented by, for example, states such as: “online”; “busy”; “idle”; “reading”; or “locked”; but being present does not necessarily mean that the presentity is available. A user, for example, may be present in a meeting, but not available to others who are not in attendance at the meeting.

A watcher is interested in the presence information of others. Prior art methods for watchers to obtain presence information include: fetching presence information once; polling for presence information at regular intervals; or by subscription to the presence information of another. Watchers may also be presentities, such as would be the case when mobile terminals 104 and 112 are visiting the same chat room within Internet 120 and are at the same time interested in each other's presence. Presence information according to the present invention may be distributed through the MMS architecture, whereby the presence information may be accessed automatically by each MMS Relay/Server (MMSC), to deliver presence information in forward or reverse MMS messaging sequences. The IETF concepts of presentities and watchers, therefore, are automatically established through the use of messaging services according to the present invention.

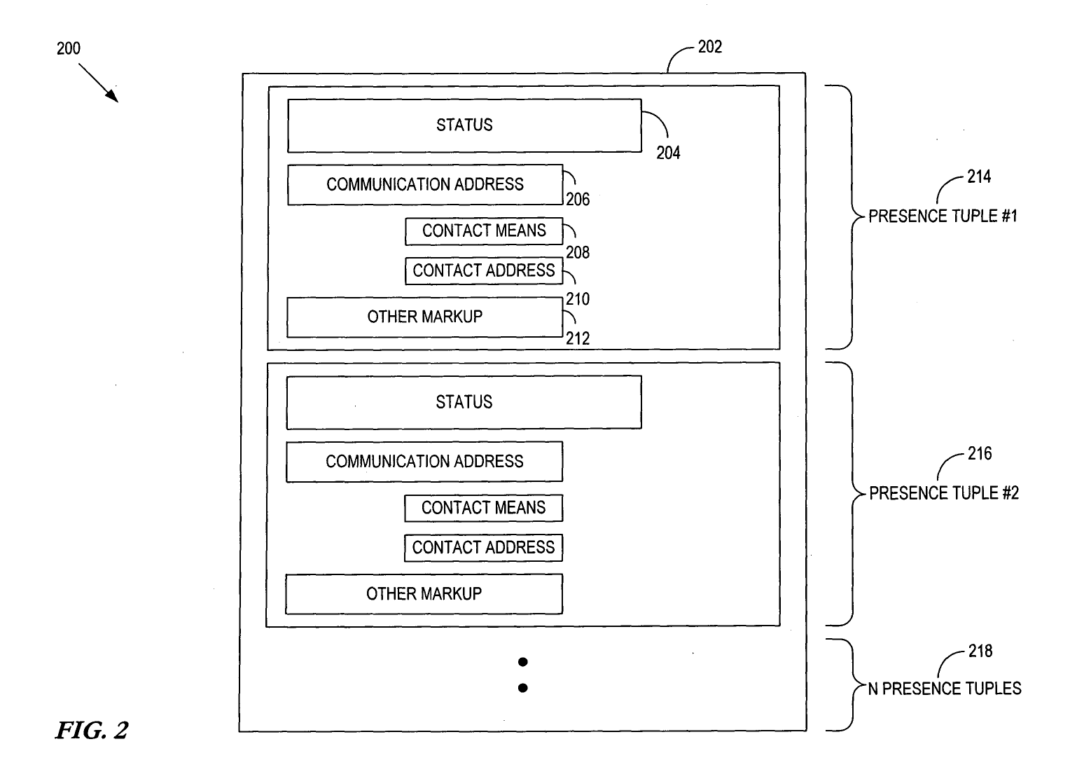

FIG. 2 illustrates exemplary format 200 of presence information 202 according to the present invention that may be stored within, for example, presence servers 102 and 132 of FIG. 1. Contained within presence information set 202 are presence tuples 214-218, where each presence tuple represents the presence information associated with each presentity reported by presence information set 202. More than one presence tuple, however, may represent a single presentity if multiple instances of the same presentity exist. For example, a mobile terminal user having multiple browser windows opened would have an equal number of presence instantiations associated with the mobile terminal user, or presentity. Each presence tuple 214-218 has a unique identifier that maps each presence tuple to its corresponding presentity.

Status marker 204 of presence tuple 214 indicates the status of its corresponding presentity. Status marker 204 might convey such information as “online”, “offline”, “busy”, “away”, or “do not disturb”. Communication address 206 includes two sub-elements: contact means 208 and contact address 210. Contact means 208 is the means through which the presence information is being conveyed, which might include MMS or some other messaging means, such as SMS or IM, for example. Contact address 210 indicates the delivery address of the presence tuple, to include a multimedia inbox address in the case of an MMS messaging means or an instant inbox address in the case of an IM messaging means. However, other possibilities exist for the contact means 208 and contact address 210 pair. For example, contact means 208 might indicate some form of telephony with the corresponding contact address 210 containing a telephone number. Other markup 212 represents a place holder for any other form of presence information that may be included for the presentity. Other markup 212 may comprise, for example, presence information that has restricted access with regard to other presentities or watchers. Other markup 212, for example, may contain information having a “private” status, whereby only those presentities or watchers having a special relationship with the current presentity may view other markup 212.

Status marker 204 is further defined to have two states that interact with message delivery according to the present invention. Status marker 204 may assume an “open” communication state that indicates an “available” or “business as usual” execution state, or may assume a “closed” communications state indicating an “unavailable” or “closed for business” execution state.

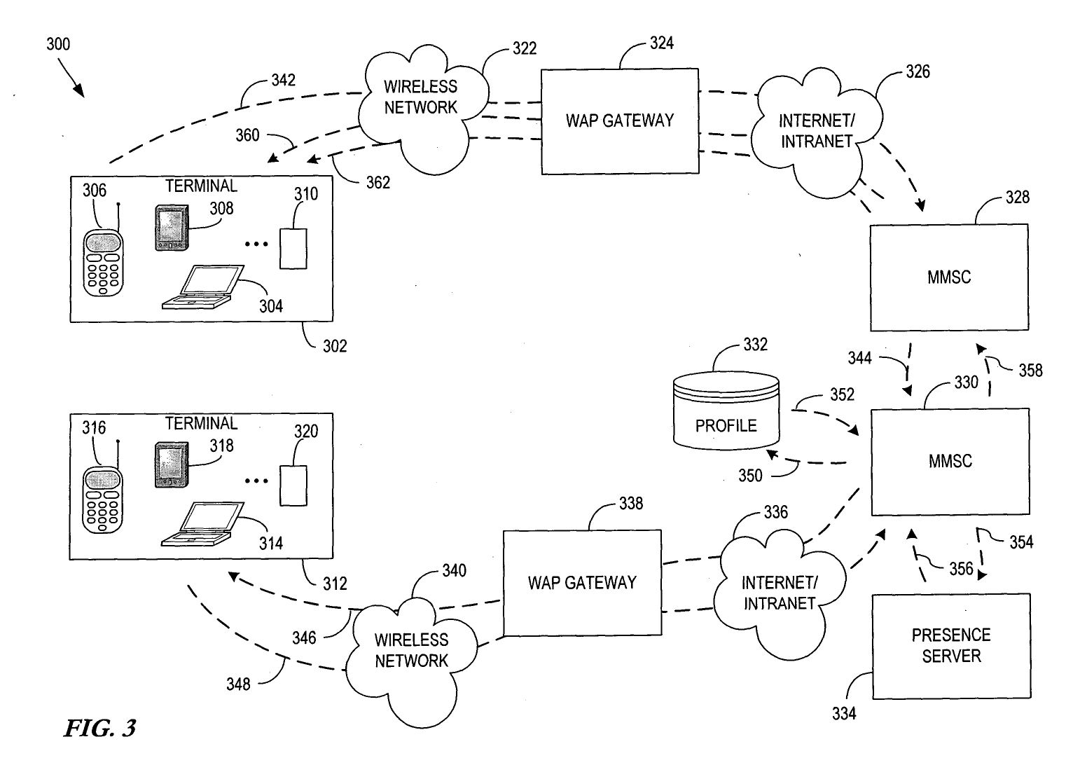

Presence information as depicted in FIG. 2, for example, is propagated using MMS acknowledgments in accordance with the present invention as exemplified by network diagram 300 of FIG. 3. Wireless terminals 302 and 312 may represent any of a number of mobile communication devices, such as cellular telephones 306 and 316, personal digital assistants (PDA) 308 and 318, notebook or laptop computers 304 and 314, or any other type of wireless terminal represented by devices 310 and 320. Wireless terminals 302 and 312 act as MMS clients that interact with MMSC 328 and 330, where MMSC 328 and 330 act as MMS proxy-relays. The interaction is consistent with the WAP model, whereby MMSC 328 and 330 act as origin servers in WAP PULL operations and as push initiators in WAP PUSH operations.

Multimedia messages between mobile terminals 302, 312 and WAP gateways 324, 338 are normally transferred using a WSP transport via wireless networks 322 and 340. The multimedia messages then transit via, for example, HTTP from WAP gateways 324 and 338 to MMSC 328 and 330 via internet/intranet 326 and 336. MMSC 328 and 330 are network entities that interact with the user's mailbox and are responsible for initiating the message receipt notification to their corresponding MMS clients, e.g., mobile terminals 302 and 312. WAP gateways 324 and 338 provide standard WAP services needed to implement MMS, such as HTTP methods, PUSH services and Over-the-Air (OTA) security.

The messaging path illustrated by FIG. 3 provides an exemplary multimedia message flow that propagates presence information in accordance with the present invention. Message 342 illustrates that a multimedia message has been sent from the A-subscriber, e.g., mobile terminal 302, having an ultimate destination to the B-subscriber, e.g., mobile terminal 312. Message 342 is a WSP/HTTP POST operation with a M-Send.req message embedded as the content body. The mandatory tokens and some interesting optional tokens of the M-Send.req message are listed in Table 1. The X-Mms-Transaction-Id is provided by mobile terminal 302 and it is a unique identifier used not

TABLE 1

| TOKEN | DESCRIPTION |
|---|---|
| X-Mms-Message-Type | Specifies the transaction type. |
| X-Mms-Transaction-ID | A unique identifier for the send request and |
| | the reply only. |
| X-Mms-MMS-Version | The MMS version number. |
| From | Address of the message sender. |
| To | Address of the recipient including the MMS |
| | proxy-relay and the recipient subscriber. |
| X-Mms-Delivery-Report | Specifies whether the sender wants a |
| | delivery report from each recipient. |
| X-Mms-Read-Reply | Specifies whether the sender wants a read |
| | report from each recipient as a new |
| | message. |
| Content-Type | The content type of the message. |

only for identification of the send request message 342, but also by MMSC 328 in identifying the confirmation response message 362. After receiving the M-Send.req message, MMSC 328 prepares confirmation response message 362 having an M-Send.conf message embedded within. Confirmation response message 362 is provided by MMSC 328 to provide mobile terminal 302 with a status code pertaining to the operation. If the WSP/HTTP POST operation is accepted by MMSC 328, then the status code will reflect an “accepted” status and it will contain a message ID that pertains to any backward messaging, such as delivery or read reports, that may be required.

The address of mobile terminal 302 is also supplied in message 342, whereby the address is either the address of mobile terminal 302, e.g., the Public Land Mobile Network (PLMN) global phone number, or an address token. If an address token is supplied, then MMSC 328 is responsible for exchanging the address token with an address of mobile terminal 302 prior to message access by mobile terminal 312. The address of both the MMSC 328 and ultimate recipient, e.g., mobile terminal 312, is also included in message 342. The address of MMSC 328 is supplied as the Uniform Resource Identifier (URI) of MMSC 328 and is, therefore, configurable within mobile terminal 302. The X-Mms-Delivery-Report and X-Mms-Read-Reply tokens specify whether mobile terminal 302 requires a delivery report and/or a read report to be delivered by mobile terminal 312. Any content included with the message is identified by the content type token and appended to the message.

MMSC 328, acting as an MMS proxy-relay, forwards the MMS message to MMSC 330 via message 344, since MMSC 330 is the serving MMSC for mobile terminal 312. To inform mobile terminal 312 that a message is available, a set of asynchronous messages, i.e., M-Notification.ind and M-NotifyResp.ind are utilized. The M-Notification.ind message is transmitted by MMSC 330 via path 346 using the WAP PUSH framework as the message body of a PUSHMSG. The information conveyed includes a URI pertaining to MMSC 330 that mobile terminal 312 uses to retrieve the multimedia message from MMSC 330. Additional information about the message may be supplied, e.g., size and expiry, so that mobile terminal 312 may determine its behavior. For example, mobile terminal 312 may delay retrieval of the message until after a user confirmation if the message exceeds a size threshold.

Upon receipt of the M-Notification.ind message, mobile terminal 312 responds via path 348 by invoking a WSP/HTTP POST operation with an M-NotifyResp.ind message embedded as the content body. The M-NotifyResp.ind message includes a retrieval status code having a value of “retrieved”, only if mobile terminal 312 has retrieved the message from MMSC 330. The operation used by mobile terminal 312 to retrieve the message from MMSC 330 is built upon the WSP/HTTP GET functionality, where the message type embedded within the message is M-retrieve.conf. Delivery of the message to mobile terminal 312 may be before or after receipt of the M-NotifyResp.ind message depending upon whether the message was delayed or retrieved immediately. In the case that a delayed retrieval is used, MMSC 330 may request an acknowledgment from mobile terminal 312.

Upon retrieval of message 344, MMSC 330 contacts profile database 332 via path 350 in order to determine whether presence information concerning mobile terminal 312 is allowed to be included in backward messaging to mobile terminal 302. Profile database 332 may contain, for example, a presence variable related to mobile terminal 312 that may be accessed via path 352 to indicate whether mobile terminal 312 presence information may be disseminated globally or should only be supplied with authorized access. Additionally, a portion of presence information concerning mobile terminal 312 may be marked for authorized access only, such as the other markup 212 portion of presence tuple 214 as illustrated in FIG. 2, while the status 204 and communication address 206 portions of presence tuple 214 are allowed global access.

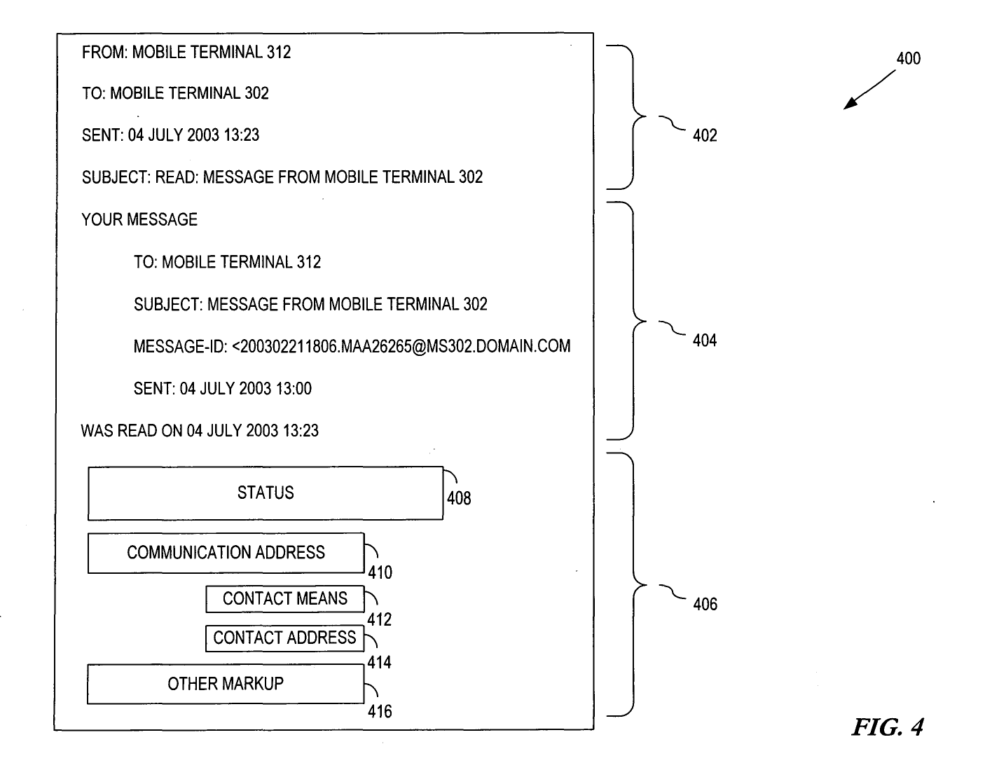

All authorized presence information may then be requested by MMSC 330 via path 354 from presence server 334 and subsequently supplied to MMSC 330 via path 356. MMSC 330 is already an authenticated and authorized user of presence server 334 because it is the responsibility of MMSC 330 to check whether the presence information associated with mobile terminal 312 can be shared with mobile terminal 302. The presence information may then be formatted within any one of a number of backward messaging formats available within MMS. In one embodiment according to the present invention, read report 400 of FIG. 4 may be supplied by MMSC 330 via path 358 in response to an affirmative value of the X-Mms-Read-Reply token of the M-Send.req message of Table 1 from mobile terminal 302. In order to permit mobile terminal 302 to ascertain that message 400 is a read report, message field 402 is provided. Message field 402 identifies the intended recipient of the original MMS message, e.g., mobile terminal 312, as well as the word “READ:” pre-pended to the subject line of the original MMS message. Body 404 of read report 400 further indicates that message 400 is a read report, since the original message ID and send time is provided.

Presence information field 406 represents a presence tuple as described in relation to FIG. 2. Status marker 408 of presence tuple 406 indicates the status of mobile terminal 312. Status marker 408 might convey such information as “online”, “offline”, “busy”, “away”, or “do not disturb”, but in this case, since the presence information is included in a read report, status marker 408 indicates an “online” status. Communication address 410 includes two sub-elements: contact means 412 and contact address 414. Contact means 412 is the means through which the presence information is being conveyed, e.g., MMS. Contact address 414 indicates the delivery address of the presence tuple, e.g., a multimedia inbox address corresponding to MMSC 330. Other markup 416 represents a place holder for any other form of presence information that may be included for mobile terminal 312. Other markup 416 may comprise, for example, presence information that has restricted access with regard to other watchers, e.g. mobile terminal 302. Since mobile terminal 302 has a special relationship with mobile terminal 312, mobile terminal 302 may view other markup 416 and thus it is included within presence tuple 406.

In another embodiment according to the principles of the present invention, a delivery report may be issued in response to an affirmative value of the X-Mms-Delivery-Report token of the M-Send.req message of Table 1 from mobile terminal 302. An exemplary delivery report message, i.e., M-Delivery.ind message, according to the present invention is illustrated in Table 2. The X-Mms-Presence-Information field of

TABLE 2

| TOKEN | DESCRIPTION |
|---|---|
| X-Mms-Message-Type | Identifies the Protocol Data Unit (PDU) |
| | type of the message, e.g., Message type |
| | value = m-delivery-ind. |
| X-Mms-MMS-Version | The MMS version number. |
| Message-ID | Identifier of the message, which connects |
| | the delivery report to the sent message of |
| | Table 1 |
| To | Address needed in case of point to |
| | multipoint broadcasting is used. |
| Date | Date and time the message was handled, |
| | e.g., fetched, expired, etc., by mobile |
| | terminal 312 or MMSC 330. |
| X-Mms-Status | The status of the message. |
| X-Mms-Presence-Information | Presence tuple as described in FIG. 2. |

Table 2 contains the presence tuple information as described in relation to FIG. 2.

It should be noted that presence information may be included in virtually any backward acknowledgment or failure reporting mechanism that is supported by the messaging service currently in use. For example, a service error with MMSC 330 may cause it to return a M-Send.conf message to mobile terminal 302 having a particular error code, but may still include the presence information associated with mobile terminal 312. Alternately, the M-Delivery.ind message is sent by MMSC 330 when it has sufficient information to conclude that either the message was delivered, or when some other status may be reported. As such, there may be cases when MMSC 330 makes decisions about the delivery status that is incorrect. For example, a timer expiry may generate an expiry notice, but mobile terminal 312 may have retrieved the message prior to its deletion. In this case, even though the X-Mms-Status field may be incorrect, the X-Mms-Presence-Information may still be correct.

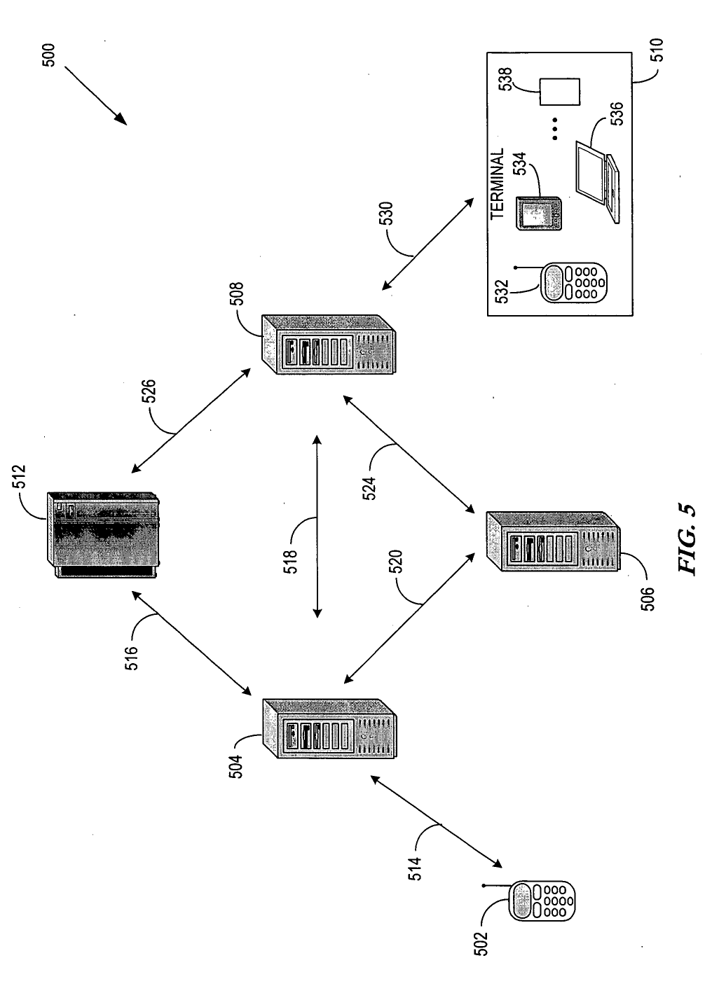

In another embodiment according to the present invention, Session Initiation Protocol (SIP) network 500 may be utilized to transfer presence information. FIG. 5 illustrates an exemplary SIP network according to the principles of the present invention to provide presence information associated with, for example, a SIP enabled mobile terminal. Elements of a SIP enabled network include user agents, e.g. mobile terminal 502 and mobile terminal 510, SIP servers 504 and 508, location server 506, a DNS server (not shown) and presence server 512. Mobile terminal 510 may be comprised of any one of a mobile phone 532, PDA 534, laptop computer 536, or other mobile device 538. User agents are the end devices in a SIP network and they originate SIP requests to establish media sessions to send and receive media. Each user agent comprises a user agent client that initiates requests and a user agent server that generates the responses to the requests.

SIP servers 504 and 508 are servers that assist user agents in session establishment and other functions. SIP servers may represent a SIP proxy that receives SIP requests from a user agent, via paths 514 or 530, or another proxy, via path 518, and forwards the request to another location. SIP servers may also represent a redirect server that receives a request from a user agent or proxy and returns a redirection response indicating where the request should be retried. SIP servers may also represent a registrar server that receives SIP registration requests and updates the user agent's information into a location server, e.g., 506, or other database, via paths 520 or 524. SIP servers 504 and 508 may also access presence information from presence server 512 via paths 516 and 526 associated with either of user agents 502 and/or 510 according to their respective access privileges defined by their user agent profiles.

SIP servers 504 and 508 may be located by any number of different methods executed by their respective user agents. User agents 502 and 510, for example, may be configured with IP addresses of a primary and a secondary SIP proxy server in much the same way that a web browser contains a default web page that it loads upon initialization. Alternately, SIP servers may be found using a DNS lookup, in which a domain name from a SIP URL is extracted and the IP address of the proxy server that supports that domain is found.

SIP address resolution is one of the most important functions of the SIP protocol because resolution of any URI, or other identifying number of a SIP message recipient, results in the IP address for the SIP message recipient. Resolution of a general name to a specific IP address automatically incorporates mobility and portability functions. In general, address resolution utilizes multiple steps and multiple SIP message hops, where each proxy consults a location server and modifies the request URI accordingly, then forwards the request to the next hop, until the request ultimately is delivered to the desired destination. The response to the request does not involve address resolution, since the response is routed back through the same path as was used by the request through use of a dedicated header which contains a chain of intermediate addresses in the request message.

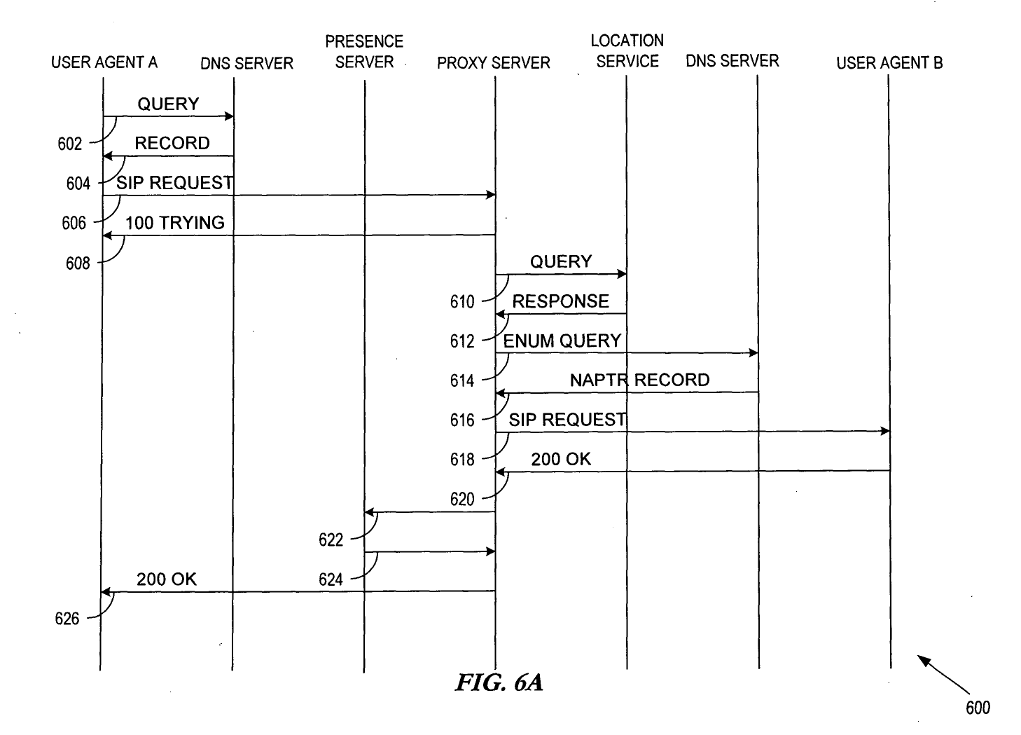

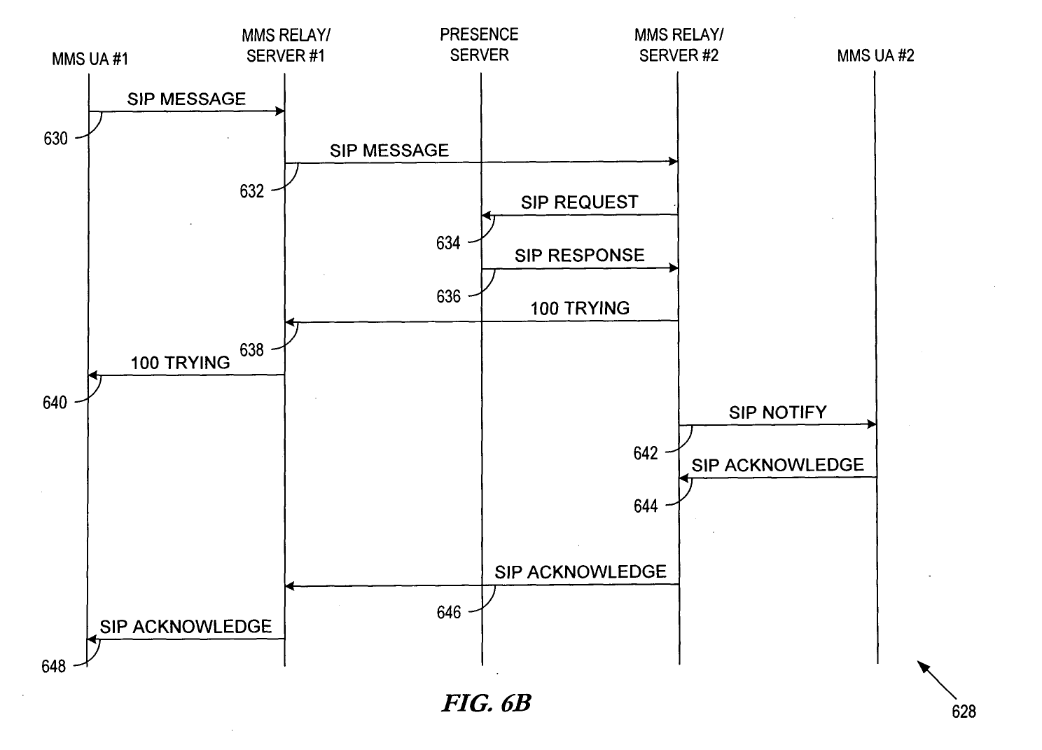

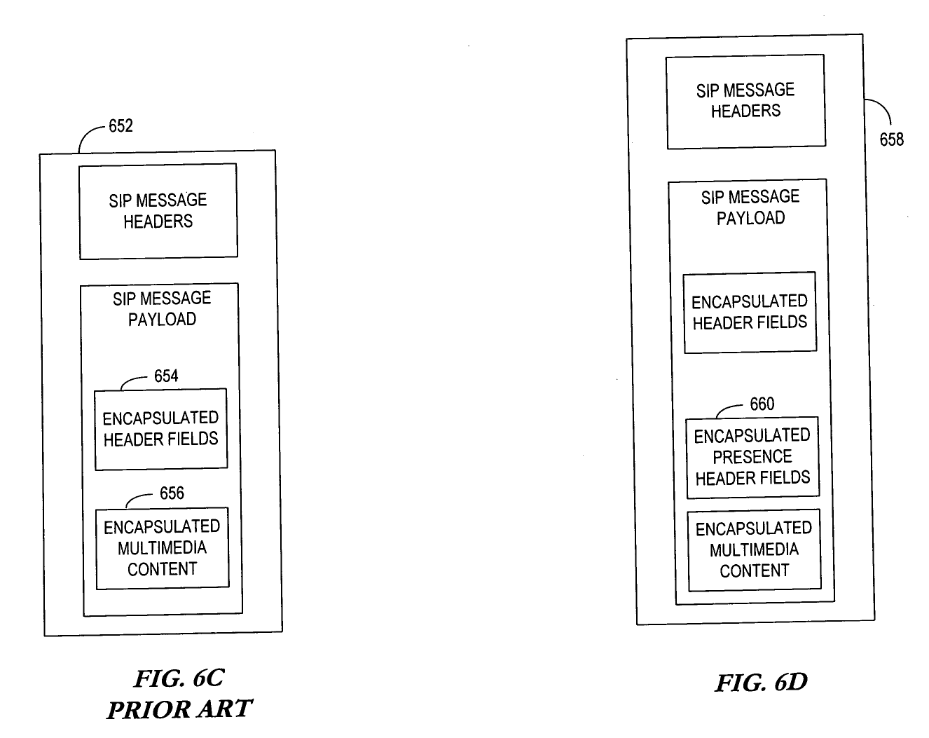

FIG. 6A illustrates basic principles of address resolution request messaging 600 that is discussed in relation to SIP network 500 of FIG. 5. User agent A, e.g., mobile terminal 502, wishes to send a general SIP request to user agent B, e.g., laptop computer 536, identified by URI “sip:UserB@domain.com”. Mobile terminal 502 first sends DNS SRV query message 602 to locate proxy server 508 that is serving the “domain.com” domain of laptop computer 536. The SRV record is returned in message 604 containing the proxy server name for proxy server 508 which is “sipproxyB.domain.com” and its associated IP address.

The SIP request is then sent to the IP address for “sipproxyB.domain.com” in message 606, which is then answered by “100 TRYING” message 608 indicating that the request is progressing, but not yet complete. Location server 506 receives DNS SRV query message 610 from proxy server 508, to which location server 506 then responds with the current registration URL for lap top computer 536, which is for example “tel:95123456789”, in message 612. Proxy server 508 then sends a DNS ENUM query with the current registration URL, “tel:95123456789”, to the DNS server in message 614. A Naming Authority Pointer (NAPTR) record is then returned from the DNS server in message 616 containing the IP address for lap top computer 536, which is, for example, “sip:UserB@100.101.102.103”.

The SIP request is then transmitted to lap top computer 536 in message 618 by proxy server 508 using the IP address “sip:UserB@100.101.102.103”. Message “200 OK” is then transmitted from lap top computer 536 to proxy server 508 in message 620. Presence information, e.g., presence tuple 214 of FIG. 2, is then requested by proxy server 508 from presence server 512 in message 622. The presence tuple is delivered to proxy server 508 in message 624 and then formatted into a SIP defined presence header. The “200 OK” message is then forwarded back to mobile terminal 502 in message 626 having presence information delivered via the presence header. The results of this initial address resolution and presence verification may then be cached and used in future requests, methods, or messaging sessions conducted between user agents 502 and 536. An exemplary 200 OK response having presence information according to the present invention is shown response message (1).
SIP/2.0 200 OK
Via: SIP/2.0/TCP 4.3.2.1:5060
To: User A<sip:UserA@domain.com
From: User B<sip:UserB@domain.com
Call-ID: a5-32-43-12-77@4.3.2.1
Presence: Status
Presence: Communication Address
Presence: Other Markup (1)

Response message (1) illustrates an exemplary 200 OK response, where the TCP transport was used via proxy server 508 having IP address 4.3.2.1 and port number 5060. The presence information associated with laptop computer 536 is automatically attached via SIP header “Presence”. The status, communication address, and other markup portions of the presence tuple is attached according to the access rights established for mobile terminal 502 in relation to the presence information associated with laptop computer 536.

FIG. 6B illustrates an alternate embodiment of SIP enabled presence information flow 628 in accordance with the present invention that is discussed with reference to MMS network 300 of FIG. 3 and SIP request message structures of FIGS. 6C and 6D. Message flow 628 assumes that all SIP registrations have been established between MMS User Agent (UA) #1, e.g., mobile terminal 302, and MMS relay/server, e.g., MMSC 328, as well as between MMS UA #2, e.g., mobile terminal 312, and MMS relay/server, e.g., MMSC 330. In another embodiment, MMS User Agents do not need to register to corresponding MMSCs, but rather to an IP Multimedia Subsystem (IMS) or to an IP Multimedia Domain (MMD).

The SIP request message is a multipart, Multi-Purpose Internet Mail Extensions (MIME) encoded message containing two parts, in no particular order. One part is of Content-Type “application/vnd.wap.mms-message” and contains the encapsulated header fields 654. The other part contains the encapsulated multimedia content 656. Message 630 represents a transmission of multimedia message content 656 that is encapsulated within prior art SIP request message structure 652 having encapsulated header fields 654. MMS relay/server #1 then relays the message to MMS relay/server #2 via message 632. Upon receipt of message 632, MMS relay/server #2 then accesses presence server, e.g., 334, via message 634 in order to request presence tuples that are associated with MMS UA #2. The presence tuples are then returned to MMS relay/server #2 via message 636. MMS relay/server #2 may then issue a 100 TRYING status message 638 to MMS relay/server #1, which is then forwarded onto MMS UA #1 via message 640. In one embodiment according to the present invention, presence tuples received from the presence server may be provided to MMS UA #1 through the use of “Presence” headers, such as those exemplified in response message (1), via the 100 TRYING status message.

Notification message 642 may then be transmitted to MMS UA #2, where encapsulated multimedia content 656 may contain either the actual content itself, i.e., direct notification, or may contain a reference to the content, i.e., indirect notification of content using, for example, a URI for content stored within MMS relay/sever #2. In one embodiment according to the present invention, a read acknowledgment may be transmitted by MMS UA #2 via message 644 having SIP message structure 652 of FIG. 6C. Once message 644 is received by MMS relay/server #2, presence tuples previously received from the presence server may be placed into encapsulated presence header fields 660, thus forming SIP message structure 658 according to the present invention to then be forwarded on to MMS UA #1 via messages 646 and 648. In another embodiment according to the present invention, MMS relay/server #2 may instead transmit a delivery report to MMS UA #1 having SIP message structure 658 if a deliver report was requested and sufficient information has been received by MMS relay/server #2 to warrant such a delivery report.

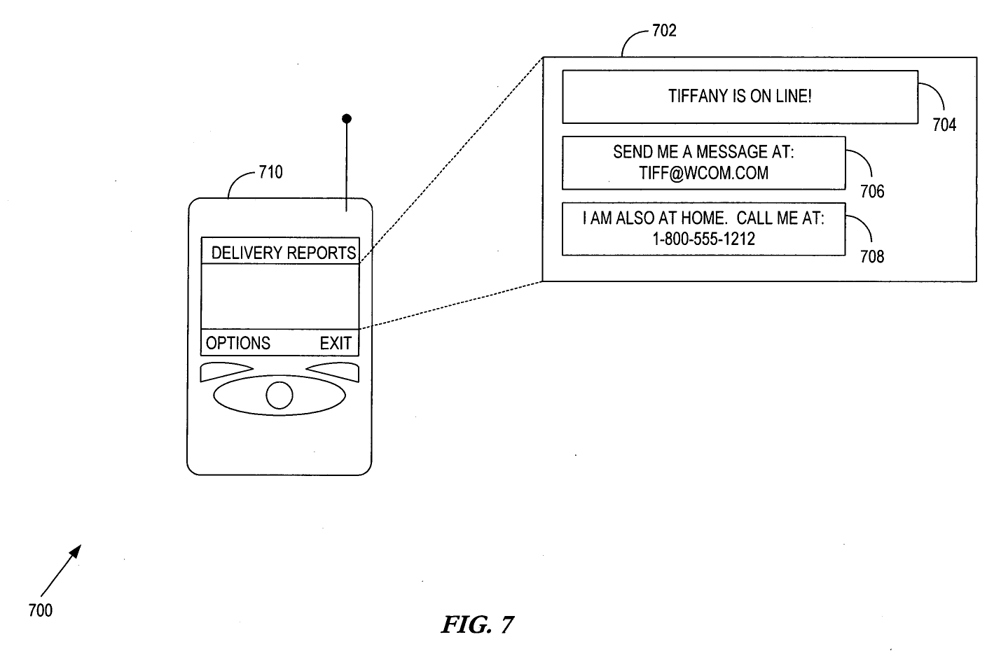

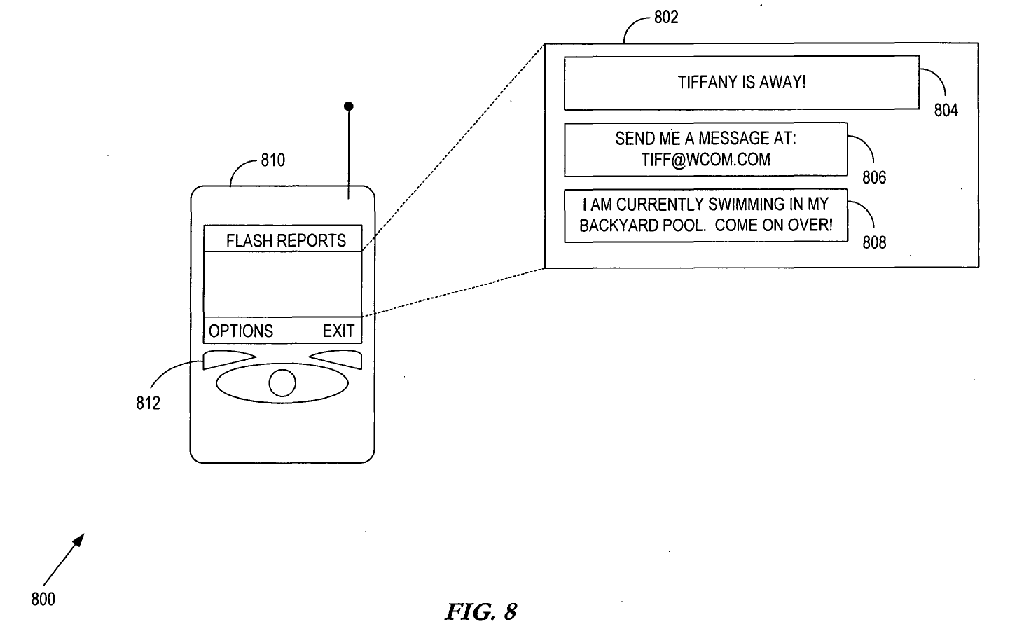

The message initiator receives presence information from the intended recipient's messaging service without the need to subscribe to the recipient's presence server in accordance with the present invention. FIG. 7 illustrates one embodiment of delivery report presentation 700 after Clark, the user of mobile terminal 710, sends a message to one of his good friends, Tiffany. Clark is provided access to Tiffany's presence information without the need to subscribe explicitly to the Presence Server. As a result of sending Tiffany a multimedia message, for example, Clark automatically receives a delivery report from Tiffany's messaging service that is subsequently saved within Clark's mobile terminal 710. Clark is notified of the automatic reception of the delivery report and navigates to the “delivery reports” menu of mobile terminal 710. The delivery reports screen 702 is then rendered onto the screen of Clark's mobile terminal 710.

Status 704 reports that “Tiffany is online!”, which provides Clark with confidence that Tiffany actually received the original multimedia message. Tiffany's contact address is provided in contact address 706, which is considered by Tiffany to be a globally accessible address. Tiffany, for example, does not mind receiving mass quantities of messages at “tiff@wcom.com” and is, therefore, willing to let her presence server publish such information to anyone. Other markup 708, however, is considered by Tiffany to be especially confidential, as it is her personal residence phone number. Since Clark is trusted by Tiffany, he has been authenticated and authorized to receive other markup 708 form Tiffany's messaging service, and thus Clark obtains another piece of presence information that allows him another option to communicate with Tiffany. Clark, for example, may now key Tiffany's home telephone number into his mobile terminal 710 and conduct voice communications with Tiffany. The delivery report may be stored within an event log portion of memory that is internal to mobile terminal 710, or may alternately be stored, e.g., within an MMS folder, which files previously sent/received MMS messages.

FIG. 8 illustrates another embodiment of delivery report presentation 800 after Clark sends a message to Tiffany. As a result of sending Tiffany a multimedia message, for example, Clark automatically receives a delivery report from Tiffany's messaging service that is not automatically saved within Clark's mobile terminal, but is instead automatically displayed to Clark on “flash reports” screen 802 of mobile terminal 810. Clark then has the option to store the delivery report into memory, or to delete the message using options key 812.

Status 804 reports that “Tiffany is away!”, which provides Clark with information that Tiffany probably did not receive the original multimedia message and the reason for the non-receipt. Tiffany's contact address is provided in contact address 806, which is considered by Tiffany to be a globally accessible address. Other markup 808, however, is considered by Tiffany to be especially confidential, as it provides information as to her current activity at her residence. Since Clark is trusted by Tiffany, he has been authenticated and authorized to receive other markup 808 form Tiffany's messaging service, and thus Clark obtains another piece of presence information that gives him the reason for Tiffany's absence. Clark may now simply visit Tiffany in person as he now knows her exact whereabouts.

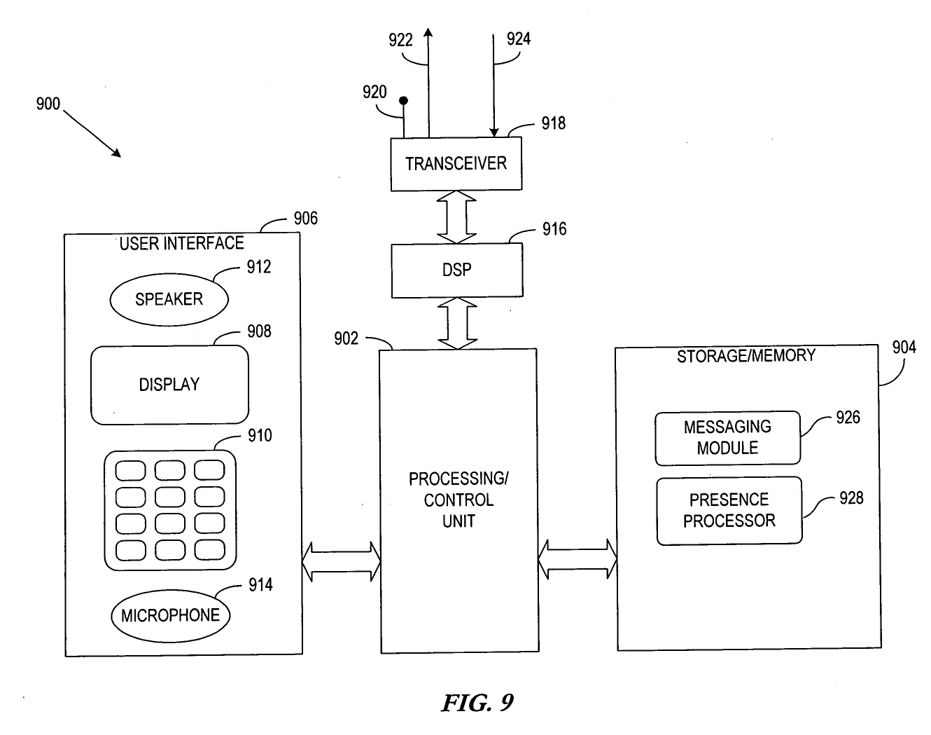

The invention is a modular invention, whereby processing functions within either a mobile terminal or a messaging server may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various presence boosted messaging functions described herein. An example of a representative mobile terminal computing system capable of carrying out operations in accordance with the invention is illustrated in FIG. 9. Those skilled in the art will appreciate that the exemplary mobile computing environment 900 is merely representative of general functions that may be associated with such mobile devices, and also that landline computing systems similarly include computing circuitry to perform such operations.

The exemplary mobile computing arrangement 900 suitable for facilitating presence boosted messaging functions in accordance with the present invention may be associated with a number of different types of wireless devices. The representative mobile computing arrangement 900 includes a processing/control unit 902, such as a microprocessor, reduced instruction set computer (RISC), or other central processing module. The processing unit 902 need not be a single device, and may include one or more processors. For example, the processing unit may include a master processor and associated slave processors coupled to communicate with the master processor.

The processing unit 902 controls the basic functions of the mobile terminal, and also those functions associated with the present invention as dictated by messaging module 926 and presence processor 928 available in the program storage/memory 904. Thus, the processing unit 902 is capable of receiving messages using messaging module 926 and processing the attached presence information using presence processor 928. The program storage/memory 904 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 904 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 900 via data signals, such as being downloaded electronically via one or more networks, such as the Internet and an intermediate wireless network(s).

The processor 902 is also coupled to user-interface 906 elements associated with the mobile terminal. The user-interface 906 of the mobile terminal may include, for example, a display 908 such as a liquid crystal display, a keypad 910, speaker 912, and microphone 914. These and other user-interface components are coupled to the processor 902 as is known in the art. Other user-interface mechanisms may be employed, such as voice commands, switches, touch pad/screen, graphical user interface using a pointing device, trackball, joystick, or any other user interface mechanism.

The mobile computing arrangement 900 also includes conventional circuitry for performing wireless transmissions. A digital signal processor (DSP) 916 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 918, generally coupled to an antenna 920, transmits the outgoing radio signals 922 and receives the incoming radio signals 924 associated with the wireless device.

The mobile computing arrangement 900 of FIG. 9 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system, apparatus, and method in accordance with the present invention.

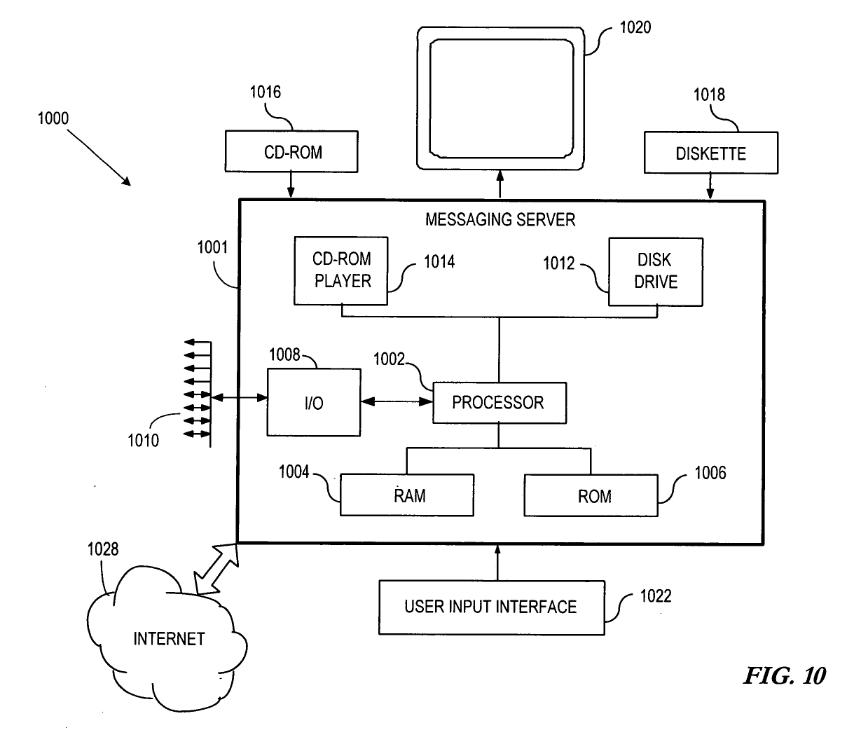

The network servers or other systems for providing messaging functions in connection with the present invention may be any type of computing device capable of processing and communicating digital information. The messaging servers utilize computing systems to control and manage the messaging activity. An example of a representative computing system capable of carrying out operations in accordance with the invention is illustrated in FIG. 10. Hardware, firmware, software or a combination thereof may be used to perform the various messaging functions and operations described herein. The computing structure 1000 of FIG. 10 is an example computing structure that can be used in connection with such a messaging system.

The example computing arrangement 1000 suitable for performing the messaging activity in accordance with the present invention includes messaging server 1001, which includes a central processor (CPU) 1002 coupled to random access memory (RAM) 1004 and read-only memory (ROM) 1006. The ROM 1006 may also be other types of storage media to store programs, such as programmable ROM (PROM), erasable PROM (EPROM), etc. The processor 1002 may communicate with other internal and external components through input/output (I/O) circuitry 1008 and bussing 1010, to provide control signals and the like. For example, a send request message such as that exemplified in Table 1 may be received by messaging server 1001 to enable the delivery of the delivery report message containing presence information as exemplified in Table 2. External data storage devices, such as presence and profile servers, may be coupled to I/O circuitry 1008 to facilitate messaging functions according to the present invention. Alternatively, such databases may be locally stored in the storage/memory of the server 1001, or otherwise accessible via a local network or networks having a more extensive reach such as the Internet 1028. The processor 1002 carries out a variety of functions as is known in the art, as dictated by software and/or firmware instructions.

Messaging server 1001 may also include one or more data storage devices, including hard and floppy disk drives 1012, CD-ROM drives 1014, and other hardware capable of reading and/or storing information such as DVD, etc. In one embodiment, software for carrying out the messaging operations in accordance with the present invention may be stored and distributed on a CD-ROM 1016, diskette 1018 or other form of media capable of portably storing information. These storage media may be inserted into, and read by, devices such as the CD-ROM drive 1014, the disk drive 1012, etc. The software may also be transmitted to messaging server 1001 via data signals, such as being downloaded electronically via a network, such as the Internet. Messaging server 1001 is coupled to a display 1020, which may be any type of known display or presentation screen, such as LCD displays, plasma display, cathode ray tubes (CRT), etc. A user input interface 1022 is provided, including one or more user interface mechanisms such as a mouse, keyboard, microphone, touch pad, touch screen, voice-recognition system, etc.

The messaging server 1001 may be coupled to other computing devices, such as the landline and/or wireless terminals via a network. The server may be part of a larger network configuration as in a global area network (GAN) such as the Internet 1028, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method for propagating presence information, comprising:
transmitting a message from a first network entity to a second network entity;
receiving the message using a messaging service of the second network entity;
gathering presence information associated with the second network entity by the messaging service; and
providing the presence information in backward messaging to the first network entity.

2. The method according to claim 1, further comprising accessing a profile server associated with the second network entity, wherein profile information accessed from the profile server governs first network entity access rights to the presence information.

3. The method according to claim 2, wherein the presence information provided to the first network entity is automatically attached to the backward messaging in accordance with the first network entity access rights.

4. The method according to claim 3, wherein the backward messaging includes one of a read report or a delivery report.

5. The method according to claim 1, wherein the backward messaging is provided by Session Initiation Protocol (SIP) signalling.

6. A messaging system, comprising:
a first terminal coupled to transmit a message;
a network element coupled to relay the message and to provide acknowledgment of message receipt to the first terminal; and
a second terminal coupled to receive the message, wherein presence information is attached to the acknowledgment by the network element to automatically update the first terminal with second terminal presence information.

7. The messaging system according to claim 6, further comprising:
a profile server coupled to provide preference information associated with the second terminal; and
a presence server coupled to provide presence information associated with the second terminal.

8. The messaging system according to claim 7, wherein the network element obtains first terminal access rights to the presence information from the profile server.

9. The messaging system according to claim 8, wherein the network element provides presence information to the first terminal in accordance with the first terminal access rights.

10. The messaging system according to claim 6, wherein the network element provides acknowledgment of message receipt using one of a read report or a delivery report.

11. The messaging system according to claim 6, wherein the network element provides acknowledgment of message receipt using signalling related to the Session Initiation Protocol (SIP).

12. A mobile terminal wirelessly coupled to a network which includes a network element capable of accessing presence information, the mobile terminal comprising:
a memory capable of storing at least one of a messaging module and a presence processor;
a processor coupled to the memory and configured by the messaging module to enable a backward message exchange with the network element; and
a transceiver configured to facilitate the message exchange with the network element, wherein the processor is configured by the presence processor to display the presence information attached to the backward message.

13. The mobile terminal according to claim 12, wherein the presence information is stored within the memory.

14. The mobile terminal according to claim 13, wherein the presence information is displayed by a delivery report menu option of the mobile terminal.

15. The mobile terminal according to claim 13, wherein the presence information is displayed from any storage location within the memory that is accessible by a display screen of the mobile terminal.

16. The mobile terminal according to claim 12, wherein the presence information is automatically displayed without user interaction.

17. The mobile terminal according to claim 16, wherein the user is provided an option to save the presence information after its automatic display.

18. A computer-readable medium having instructions stored thereon which are executable by a first mobile terminal for exchanging messages by performing steps comprising:
transmitting a message to a second mobile terminal;
receiving an acknowledgment message from a messaging service of the second mobile terminal; and
displaying presence information contained within the acknowledgment message, wherein the presence information is populated by the messaging service.

19. A server within a network used to facilitate an exchange of messages, comprising:
means for receiving a message from a first terminal;
means for extracting presence information associated with a recipient of the message; and
means for providing the presence information to the first terminal in a backward message.

20. The server according to claim 19, further comprising means for extracting profile information associated with the recipient of the message.

21. The server according to claim 20, further comprising means for filtering the presence information provided in accordance with the profile information.

22. A computer-readable medium having instructions stored thereon which are executable by a network server for facilitating messaging by performing steps comprising:
receiving messages from a first network terminal;
obtaining presence information associated with a recipient of the messages;
formatting the presence information into a backward message in accordance with profile information associated with the recipient of the messages; and
sending the backward message to the first network terminal.
